(19) United States
(12) Patent Application Publication
(10) Pub. No.: US 2017/0087804 A1
(43) Pub. Date: Mar. 30, 2017

(54) BULK METALLIC GLASS LAMINATES AND METHODS OF FABRICATING THE SAME

(71) Applicant: Crucible Intellectual Property, LLC, Rancho Santa Margarita, CA (US)

(72) Inventors: Stephanie O'Keeffe, Rancho Santa Margarita, CA (US); Joseph W. STEVICK, Olympia, WA (US)

(21) Appl. No.: 15/280,895

(22) Filed: Sep. 29, 2016

Related U.S. Application Data
(60) Provisional application No. 62/235,092, filed on Sep. 30, 2015.

(51) Int. Cl. B32B 5/02; B32B 37/10; B32B 37/06

(52) U.S. Cl. CPC B32B 5/02; B32B 37/06; B32B 37/10; B32B 2457/00; B32B 2262/106; B32B 2262/103

(57) ABSTRACT

Laminate BMG-fiber feedstock and parts made from one or more fiber layers and two or more bulk metallic glass (BMG) layers are described herein. The hot formed BMG-fiber laminates have vastly superior strength, ductility and use parameters as compared to the fiber or BMG alone as well as to conventional metal-fiber weaves. Methods of formation for both the BMG-fiber laminate and for near-to-net parts made therefrom are also provided.

### CROSS-REFERENCE TO RELATED APPLICATION(S)

This application is a non-provisional patent application of U.S. Provisional Patent Application No. 62/235,092, filed Sep. 30, 2015 and titled “BULK METALLIC GLASS LAMINATES AND METHODS OF FABRICATING THE SAME,” the disclosure of which is herein by reference in its entirety.

### FIELD

The disclosure relates generally to bulk metallic glass containing laminates and more particularly to laminates having interposed layers of bulk metallic glass and fiber.

### BACKGROUND

Metal-fiber laminates are hybrid composite materials built up from interposed layers of metal and fiber. Metal-fiber laminates take advantage of the hybrid nature of the constituent layers, for example, laminates provide better damage tolerance to fatigue than either metal alone or fiber alone. Both the choice of metal constituent for the metal layer and fiber(s) for the fiber layer can be optimized to provide laminates having target parameters for an intended use.

Generally, metal-fiber laminates are formed by using an adhesive to combine a metal layer to a fiber layer. These forming techniques take advantage of adhesives that allow for cross-linking and chemical bonding between the metal and fiber layers of the laminate, particularly when heat to cure the adhesive is applied. Although highly useful, conventional metal-fiber laminates are limited by the bonding strength of the adhesives used between the metal and fiber layers. Conventional metal-fiber laminates are also difficult to fabricate as they involve a variety of fabrication techniques (curing) including vacuum bagging, autoclaving, out-of-autoclaving, and/or heat pressing. As such, there is a need in the art to form metal-fiber laminates not dependent on adhesives and adhesive curing techniques.

Bulk metallic glass is a family of rapidly solidifying glass-forming alloy melts. In general, bulk metallic glass provides amorphous metals that have enhanced strength, hardness and elasticity over other metals and alloys. However, the benefits of bulk metallic glass are dependent on the bulk metallic glass maintaining an amorphous state, which in turn often limits the thickness that a bulk metallic glass melt may attain. When heated, a bulk metallic glass must cool at a rate that retains the amorphous character of the material, a rate that typically requires heat be removed from the BMG during cooling. Removal of heat from the bulk metallic glass becomes a limiting factor on the thickness of the bulk metallic glass.

Crystal formation in a BMG is typically due to insufficient cooling rates of the melted BMG feedstock. As such, when a BMG part is being fabricated from BMG feedstock, a risk in the creation of the part is partial crystallization of the BMG due to insufficient cooling. Insufficient cooling can be difficult to quantify, but crystal formation in a bulk metallic glass can have significant effects on the strength and failure rate of a desired BMG composed part. As such, there is a need in the art to overcome issues dependent on BMG fabrication and the inherent likelihood that BMG formed parts may have some level of crystallization therein.

### SUMMARY

Embodiments herein provide BMG-fiber laminate feedstock and BMG-fiber laminate near-to-net shaped fabricated parts.

BMG-fiber laminate feedstock and parts, as described herein, show improvement over other metal-fiber laminates with regard to a number of relevant parameters including strength, elasticity, and impact resistance. As described in detail below, BMG-fiber laminates do not rely on the use of an adhesive or chemical bonding between the BMG and fiber materials.

BMG-fiber laminates also show improvements over BMG alone where crystallization of the BMG is of concern. BMG-fiber laminates can provide thicker feedstock where crystal formation is of significantly lower concern due to the incorporation of fiber materials in the BMG-fiber laminates.

Embodiments herein provide BMG-fiber laminate feedstock having a composite structure of at least one layer of fiber or fiber matrix sandwiched and embedded between at least two layers of BMG. Additional layers of fiber and BMG, for example, 2 layers of fiber interposed between 3 layers of BMG, 3 layers of fiber interposed between 4 layers of BMG, and the like, are also provided. BMG-fiber laminates typically include an alternating BMG, fiber, BMG, fiber, BMG layer pattern.

Fiber layers may be continuous or non-continuous throughout a BMG-fiber laminate. In typical embodiments a density of fiber in a fiber layer is utilized that allows for the intended laminate use. In some aspects, two or more different fiber materials can be used in a layer (different types of fiber intermingled or weaved in the same layer) or, where a BMG-fiber laminate includes multiple fiber layers, the layers can be of the same, or of different fiber, e.g., a laminate including a first layer of carbon and a second layer of aluminum, i.e., BMG/carbon fiber/BMG/aluminum fiber/BMG.

Typical fiber materials for use herein include: carbon, polyimide film, titanium, aluminum, glass, and aramids. Fiber layers can be unidirectional or formed into weaves as need requires.

Typical BMG materials for use herein include any of the class of metallic materials that solidify and cool at relatively slow rates and that retain an amorphous, non-crystalline state at room temperature. BMG layers for use in laminate structures are typically at least 0.05 mm in thickness and more typically at least 0.1 mm or 0.5 mm in thickness. In some embodiments the BMG layer is between about 0.1 mm and about 5 mm in thickness and more typically between about 0.5 mm and 3 mm in thickness.

Fabrication of BMG-fiber laminates typically involves thermoplastically heating the composite of layers to a viscosity such that the BMG becomes viscous and surrounds and embeds the fiber layer(s). Viscous BMG, after embedding a fiber layer, is quenched to avoid crystal formation.

Embodiments herein also cover an electronic device having a housing composed of a BMG-fiber laminate, a display positioned within the housing, and a cover sheet. The BMG-fiber laminate has at least one fiber layer sandwiched between two or more BMG layers. In some aspects the fiber layer is a carbon layer, in other aspects the fiber layer is an aluminum layer. The BMG-fiber laminate is typically from 0.5 to 3 mm in thickness.

Embodiments herein also include BMG-fiber laminate parts. BMG-fiber laminate parts are fabricated at near-to-net shape, for example, a near-to-net BMG-fiber laminate housing for use on a laptop. In aspects disclosed herein, the laminate parts can be fabricated by thermoplastically heating a BMG layer and pressing the BMG into a desired mold. A fiber layer is then added to the viscous BMG material, followed by a second thermoplastically heated layer of BMG. Formed laminate parts are then appropriately quenched. In other aspects disclosed herein, the laminate parts can be fabricated by thermoplastically heating a BMG and a first fiber layer and pressing the two layer laminate into the desired mold, then adding or pressing a thermoplastically heated BMG layer to the two layer laminate to form the fabricated near-to-net shaped part. Additional layers are added in a stepwise fashion. Alternatively, a completed BMG-fiber composite of the desired laminate structure may be thermoplastically heated and pressed into the mold, the mold quenching the formed near-to-net shaped part.

Methods for fabricating both BMG-fiber laminates and near-to-net shaped BMG-fiber laminate parts are also disclosed. Methods include identifying the composite laminate structure required for an intended use; identifying the heating parameters required for the BMG and fiber layer(s) such that the thermoplastic heating does not damage the fiber material; thermoplastically heating the composite structure such that the BMG fully embeds and mechanically bonds to the internal fiber layer; quenching the resultant BMG-fiber laminate to avoid crystal formation; and, where necessary, using post-processing techniques to modify the BMG-fiber laminate.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a viscosity diagram of an exemplary bulk solidifying amorphous alloy.

FIG. 2 is a time-temperature-transformation (TTT) diagram for an exemplary bulk solidifying amorphous alloy.

FIG. 3 is a schematic of a fiber weave layer.

FIG. 4 is a cross-sectional view of a BMG/fiber/BMG composite prior to (left) and after (right) hot forming.

FIG. 5 is a schematic showing a cross-sectional view of a BMG/fiber/BMG composite prior to (left) and after (right) hot forming.

FIG. 6 is a flow chart of methods for forming BMG-fiber laminates.

FIG. 7A is a perspective top view of a BMG-fiber laminate.

FIG. 7B is a perspective view of a fiber layer extending out from between two BMG layers in a hot formed BMG-fiber laminate.

FIG. 7C is a perspective view of a BMG-fiber laminate.

FIG. 7D is a perspective view of a fiber layer embedded in a single underlying heated BMG layer.

FIG. 8A is a perspective view of a 1.5″×1.5″ piece of dry carbon fiber.

FIG. 8B is a perspective view of a 3″×3″ piece of dry carbon fiber.

FIG. 8C is a perspective view of a composite structure having a 1.5″×1.5″ dry carbon fiber layer on a 1.77″×1.77″ piece of BMG.

FIG. 8D is a perspective view of a pre-formed composite having a 3″×3″ dry carbon fiber piece sandwiched between two 1.77″×1.77″ BMG pieces.

FIG. 8E is a perspective view of a pre-formed composite of the 1.5″×1.5″ dry carbon fiber piece sandwiched between two 1.77″×1.77″ BMG pieces.

FIG. 8F is a perspective view of a hot forming device in accordance with embodiments herein.

FIG. 9 shows a formed BMG-fiber laminate having a 1.5″×1.5″ dry carbon fiber layer sandwiched between two 1.77″×1.77″ BMG layers (top) and a 3″×3″ dry carbon fiber layer sandwiched between two 1.77″×1.77″ BMG layers (bottom).

### DETAILED DESCRIPTION

All publications, patents, and patent applications cited in this document are hereby incorporated by reference in their entirety.

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments herein provide bulk metallic glass (BMG)-fiber laminate feedstock, and to the methods of producing the same.

Embodiments herein also provide desired parts formed from BMG-fiber laminates and to methods of producing the laminate-based parts in near-to-net shape.

BMG-fiber laminate embodiments herein show improvement over other metal or metal-laminate materials with regard to increased damage tolerance to crack growth, and provide increased mechanical properties to the composite structure, such as increased impact resistance, increased fracture toughness, increased fatigue life, and increased ductility. BMG layers for use in laminate structures are typically at least 0.05 mm in thickness and more typically at least 0.1 mm or 0.5 mm in thickness. In some embodiments the BMG layer is between about 0.1 mm and about 5 mm in thickness and more typically between about 0.5 mm and 3 mm in thickness. The BMG-fiber laminate materials are useful in the fabrication of BMG parts.

BMG-fiber laminate embodiments herein also show improvement over other metal or metal-laminate materials with regard to laminate strength, where BMG-laminates, as disclosed herein, benefit from the intrinsic properties of BMG, as well as from the BMG-fiber laminate structure, as discussed in greater detail below. Note that the mechanical interactions between the BMG layers and fiber layer(s) are superior to chemical bonding found between metal layers adhered to fiber layers in conventional laminates.

BMGs are a class of amorphous metal materials that may be solidified and cooled at relatively slow rates such that they retain their amorphous, non-crystalline, state at room temperature. BMGs have increased strength and can be elastically deformed as compared to other metals, as well as show resistance to corrosion and be quite durable under hostile environmental conditions. However, BMGs can also exhibit some volume of crystallinity (as compared to amorphicity) due to insufficient cooling of heated BMG or due to the presence of unwanted impurities within the BMG. Where crystallinity is at issue, the BMG may have limited ductility, particularly when loaded in tension, and may tend to fail in non-evident or unexpected fashions.

BMG-fiber laminate embodiments herein are a class of composite materials where plies of fiber are layered with BMGs to provide laminates with desirable characteristics. As such, BMG-fiber laminates according to embodiments herein combine the positive characteristics of the fiber with the positive characteristic of BMG. The combination of BMG and fiber provides impact resistance, high strength, high strength-to weight ratio, and high energy dissipation. Further, the addition of fiber layers integrated with BMG limits cracking or other failure associated with BMG and BMG with crystallinity.

Fiber laminate layers act to minimize the defects caused by crystal formation in BMG allowing for practical application in parts that require low failure rates. In addition, the combination of BMG and fiber provides a mechanical interaction not possible to conventional metal-laminates, which rely on adhesives and chemical bonding. As such, BMG-laminates, for example, are recognized for possible use in shields for space vehicles, provide protection for micro-meteoroid orbital debris (whipple shield), for replacement of GLARE or ARALL composite materials in both civilian and military uses, and may be used in housings for electronic devices where strength and durability are required, e.g., housing for a laptop.

### Bulk Metallic Glass (BMG)

BMGs are a class of metallic materials that may be solidified and cooled at relatively slow rates, and that retain their amorphous, non-crystalline state at room temperature. However, if the cooling rate of an amorphous alloy is not sufficiently high, crystals may form inside the alloy during cooling, so that the benefits of the amorphous state can be lost. One challenge to fabrication of BMG parts is partial crystallization due to insufficient cooling rates. Crystal formation in a BMG provides a level of uncertainty to the quality of parts formed therefrom, uncertainty that can translate to increased costs and failure rates for the parts fabricated.

BMG parts are often formed from thin layers of BMG to avoid crystal formation associated with cooling issues. In essence, in order to attain the proper cooling rate, heat must be removed from the BMG, a process that becomes more and more difficult the thicker the BMG layer becomes. As such, thicker BMG layers tend to include some level of crystallization. As can be shown herein, BMG-fiber laminates provide thicker BMG-based feedstock, less dependent on crystal formation.

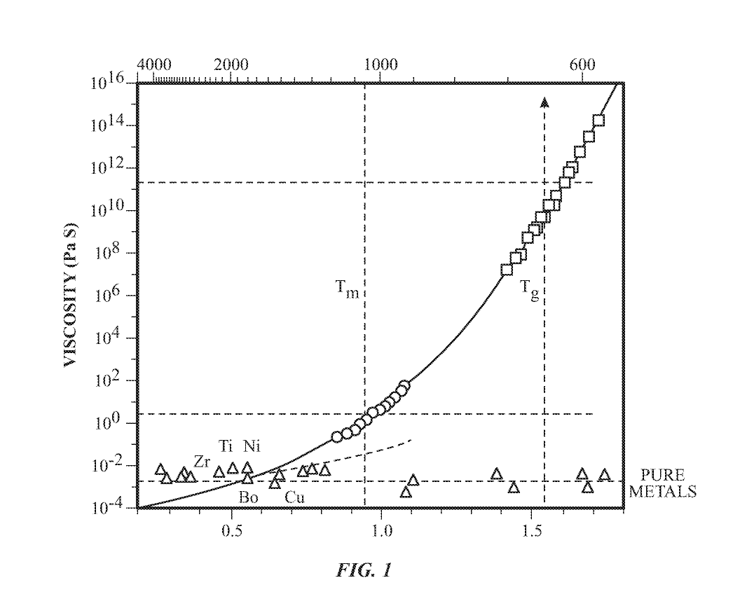

FIG. 1 shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a BMG during the formation of an amorphous solid. The molten alloy becomes more and more viscous with increased undercooling until it approaches solid from around the glass transition temperature (Tg). Accordingly, the temperature of the solidification front for BMGs can be around the Tg, where the alloy will practically act as a solid for purposes of pulling out the quenched amorphous sheet product.

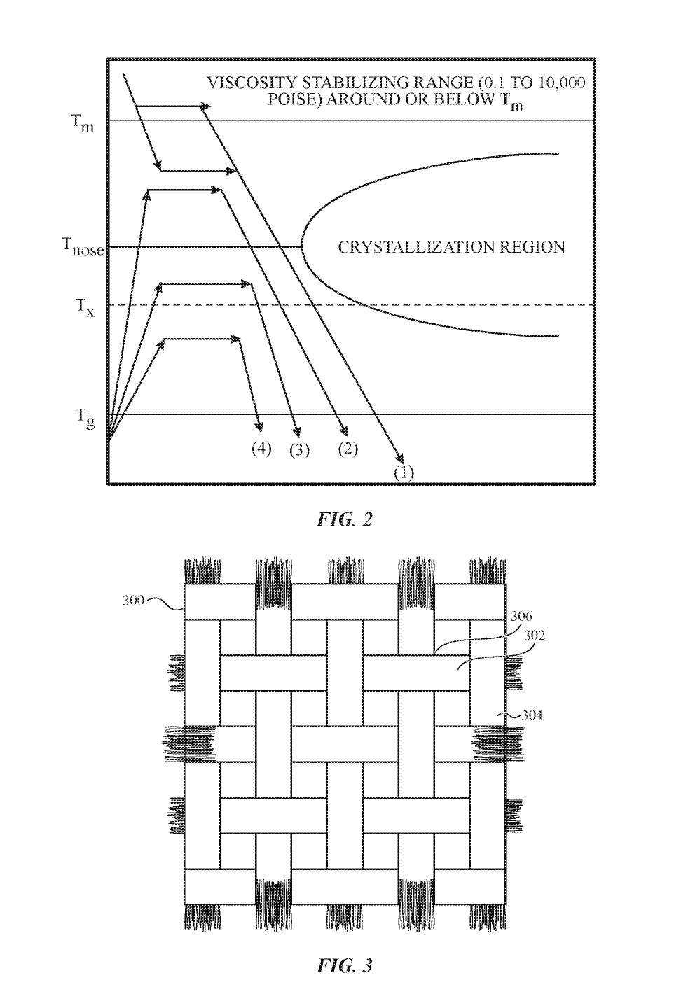

FIG. 2 shows a time-temperature-transformation (TTT) cooling curve of an exemplary BMG. BMGs do not experience a liquid/solid crystallization transformation upon cooling, as with conventional metals. Rather, the highly fluid, non-crystalline form of the metal found at high temperatures (near a melting temperature Tm) becomes more viscous as the temperature is reduced (near a Tg), eventually taking on the outward physical properties of conventional solids.

Although there is no liquid/crystallization transformation for a BMG, a “melting temperature” Tm may be defined as the thermodynamic liquidus temperature of the corresponding crystalline phase. The viscosity of the BMG at the melting temperature could lie in the range of about 0.1 poise (or lower) to about 10,000 poise. A lower viscosity at the melting temperature would provide faster and complete filling of intricate portions of a mold with a BMG for forming the BMG-fiber laminates and laminate parts. The cooling rate of the molten metal to form a BMG-fiber laminate part has to be such that the time-temperature profile during cooling does not traverse through the nose-shaped region (Tnose) bounding the crystallized region in the TTT diagram of FIG. 2. In FIG. 2, the crystallization temperature Tx is where crystallization is most rapid and occurs in the shortest time scale.

The supercooled liquid region, the temperature region between Tg and Tx, is a manifestation of the extraordinary stability against crystallization of BMGs. In this temperature region the BMG can exist as a high viscosity liquid. The viscosity of the BMG in the supercooled liquid region can vary between 10¹² Pas at the Tg down to 10⁵ Pas at the Tx, the high temperature limit of the supercooled liquid region. Liquids with such viscosities can undergo substantial plastic strain under an applied pressure. BMGs used in laminate embodiments herein make use of the large plastic formability in the supercooled liquid region.

Note that as used herein the term “alloy” refers to a homogenous mixture or a solid solution of two or more metals, the atoms of one replacing or occupying interstitial positions between the atoms of the other, for example, brass is an alloy of zinc and copper. The term “alloy” can also refer to an alloy-containing composite, i.e., a mixture or solid solution having two or more metals and including composite materials.

Also note that as used herein the term “amorphous” or “non-crystalline” refers to a solid that lacks lattice periodicity, which is characteristic of a crystal. As used herein, an amorphous solid includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

An “amorphous alloy” is an alloy having an amorphous content. Note that, amorphous by volume means to exhibit a disorderly atomic scale or arrangement as compared to most metals, which are highly ordered in atomic structure. Materials in which such a disordered structure is produced directly from the liquid state during cooling are often referred to as “glasses,” hence the name BMG. There are additional ways besides rapid cooling to produce amorphous metals, including physical vapor deposition and melt spinning. Regardless, BMGs are considered to be a class of materials and will be treated as such throughout this disclosure.

BMGs can be produced through a variety of quick-cooling methods, including sputtering molten metal onto a spinning metal disk or by critical cooling low enough to allow formation of amorphous structure.

BMGs may contain atoms of significantly different sizes, leading to low free volume and high viscosity in a molten state. High viscosity prevents the atoms from moving enough to form an ordered lattice. Further, the amorphous alloy structures also results in low shrinkage during cooling and resistance to plastic deformation.

Thermal conductivity of BMGs may be lower than that of their crystalline counterparts. To achieve formation of an amorphous structure even during slower cooling, the alloy may be made of three or more elements, leading to complex crystal units with higher potential energy and lower probability of formation. Formation of BMGs depends on several factors including: the identity and number of elements of the alloy; the atomic radius of the elements (typically over 12% difference to achieve high packing density and low free volume); and the negative heat of mixing the combination of elements.

A material can have an amorphous phase, a crystalline phase, or both. The amorphous and crystalline phases can have the same chemical composition and differ only in the microstructure, i.e., one amorphous and the other crystalline. Alternatively, the two phases can have different chemical compositions and microstructures. For example, a composition can be partially amorphous, substantially amorphous or completely amorphous.

As noted above, the degree of amorphicity can be measured by fraction of crystals present in an alloy. The degree can refer to volume fraction or weight fraction of the crystalline phase present in an alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. A composition that is at least substantially amorphous, can refer to one of which at least about 90 vol % is amorphous, such as at least about 95 vol %, such as at least about 98 vol %, such as at least about 99 vol %, such as at least about 99.5 vol %, such as at least about 99.8 vol %. In some embodiments, a substantially amorphous composition can have some incidental, insignificant amounts of crystalline phase present therein. In such cases the substantially amorphous composition may be considered 100 vol % amorphous.

The laminate embodiments herein may include layers applicable to any type of BMG. The BMG can comprise the element zirconium, (Zr), hafnium (Hf), titanium (Ti), copper (Cu), nickel (Ni), platinum (Pt), palladium (Pd), iron (Fe), magnesium (Mg), gold (Au), lanthanum (La), silver (Ag), aluminum (Al), molybdenum (Mo), niobium (Nb), beryllium (Be) or a combination thereof. Namely the BMG can include any combination of these elements in its chemical formula or chemical composition. The elements can be present at different weight or volume percentages. For example, an iron based BMG can refer to a BMG having a non-insignificant weight percentage of iron present therein. Alternatively, BMGs herein can be zirconium based, titanium based, platinum based, palladium based, silver based, copper based, iron based, nickel based, aluminum based, molybdenum based and the like. The BMGs herein can also be free of any of the aforementioned elements to suit a particular purpose. For example, embodiments can include a BMG that is substantially free of nickel, aluminum, titanium and the like.

BMGs of embodiments herein may have the formula (Zr,Ti)ₐ(Ni,Cu,Fe)_{b}(Be,Al,Si,B)_{c}, wherein “a”, “b” and “c” each represent a weight or atomic percentage. In one embodiment, “a” is in the range of from 30 to 75, “b” is in the range of from 5 to 60, and “c” is in the range of from 0 to 50. Alternatively, an amorphous alloy can have the formula (Zr,Ti)ₐ(Ni,Cu)_{b}(Be)_{c}, where “a”, “b”, and “c” each represents a weight or atomic percentage. In one embodiment, “a” is in the range of from 40 to 75, “b” is in the range of from 5 to 50 and “c” is in the range of from 5 to 50. In another embodiment the alloy can also have the formula (Zr,Ti)ₐ(Ni,Cu)_{b}(Be)_{c}, where “a”, “b”, and “c” each represents a weight or atomic percentage. Here “a” can be in the range of from 45 to 65, “b” is in the range of from 7.5 to 35, and “c” is in the range of from 10 to 37.5. In still another embodiment, the alloy can have the formula (Zr)ₐ(Nb,Ti)_{b}(Ni,Cu)_{c}(Al)_{d}, where “a”, “b”, “c”, and “d” each represents a weight or atomic percentage. Here “a” is in the range of from 45 to 65, “b” is in the range of from 0 to 10, “c” is in the range of from 20 to 40 and “d” is in the range of from 7.5 to 15. One illustrative embodiment is a Zr—Ti—Ni—Cu—Be based alloy under the tradename Viteloy™.

Other exemplary BMG includes ferrous metal-based alloys. For example, compositions for inclusion herein are disclosed in US Pat. Application Publication Nos. 2007/0079907 and 2008/0118387. Compositions include a Fe(Mn, Co, Ni, Cu)(C, Si, B, P, Al) system, wherein the Fe content is from 60 to 75 atomic percent, the total of (Mn, Co, Ni, Cu) is in the range from 5 to 25 atomic percent, and the total of (C, Si, B, P, Al) is in the range of from 8 to 20 atomic percent. One illustrative composition is Fe₄₈Cr₁₅Mo₁₄Y₂C₁₅B₆. These embodiments also include systems described by Fe—Cr—Mo—(Y,Ln)-C—B, Co—Cr—Mo-Ln-C—B, Fe—Mn—Cr—Mo—(Y,Ln)-C—B, (Fe, Cr, Co)—(Mo, Mn)—(C, B)—Y, Fe—(Co, Ni)—(Zr,Nb, Ta)—(Mo, W)—B, Fe—(Al, Ga)—(P, C, B, Si, Ge), Fe—(Co, Cr, Mo, Ga, Sb)—P—B—C, (Fe, Co)—B—Si—Nb, and Fe—(Cr—Mo)—(C, B)-TM, where Ln denotes a lanthanide element and TM denotes a transition metal element.

BMGs herein also include ferrous alloys, such as (Fe, Ni, Co), a few illustrative Fe based alloys include: Fe₇₂Al₅Ga₂P₁₁C₆B₄ and Fe₇₂Al₇Zr₁₀Mo₅W₂B₁₅. Illustrative alloys are described in U.S. Pat. Nos. 6,325,868, 5,288,344, 5,368,659, 5,618.

As can be envisioned, BMG embodiments herein can further include additional elements, such as additional transition metal elements, including niobium, chromium (Cr), vanadium (V) and cobalt (Co). The additional elements can be present at less than or equal to about 30 wt %, 20 wt %, 10 wt %, 5 wt %, 1 wt %. Optional elements may also include: manganese, zirconium, tantalum, tungsten, yttrium, titanium, and hafnium. Further optional elements may include phosphorous, germanium, and arsenic, totaling up to 2% and likely less than 1 wt % of the total.

Note that BMGs may also include a small amount of impurities. In some instances the impurities are added to modify the properties of an alloy. In other instances the impurities are present as inevitable, incidental impurities, such as those obtained as a byproduct of processing and manufacturing. Impurities can be less than or equal to 10 wt %, 5 wt %, 2 wt %, 1 wt %, 0.5 wt %, and 0.1 wt %. As discussed below, one of the unexpected benefits of embodiments described herein is that BMG-laminate structures overcome the presence of impurities in a BMG, even where the impurities have led to crystal formation in the resultant BMG material.

BMG formed layers are typically pre-formed for laminate use. BMG layers for use in laminate structures herein are typically at least 0.05 mm in thickness and more typically at least 0.1 mm or 0.5 mm in thickness. In some embodiments the BMG layer is between about 0.5 mm and about 5 mm in thickness and more typically between about 0.5 mm and about 4 mm in thickness. Often the thickness of a BMG layer is dependent upon the amount of alloy required to viscously intermingle with a desired fiber layer. Although typical, BMG layers in the same BMG-fiber laminate do not have to be of the same thickness or composition as long as the forming temperature is sufficient to thermoplastically form the layers and the layers have sufficient material to intermingle in the fiber layer (discussed in greater detail below).

### Fibers and Fiber Weaves

Embodiments herein include the use of fiber or fiber material in the formation of BMG-fiber laminates. Fibers for use herein typically contribute increased mechanical properties to the BMG-fiber laminates. BMG-fiber laminate embodiments include designs directed at improving a mechanical property that is lacking in the fiber, fiber matrix, or BMG alone.

Illustrative fiber or fiber materials for use herein include: carbon, polyimide film, e.g., Kapton®, titanium, aluminum, glass or glass wool, aramids, e.g., Kevlar®, Twaron®, Nomex®, PBO fibers, polyethylene or polypropylene fibers, flax, hemp, and other like materials. In some embodiments the fiber layer is composed of a combination of fibers based on the desired BMG-fiber laminate properties, for example, a fiber layer composed of carbon and aluminum fibers, or of titanium, aluminum and aramid fibers, etc.

Fiber layers may be assembled with fiber orientation at 0, +/−45° and/or 90°. Assembled fiber may optionally be reinforced using matrix materials, such as polymers, e.g., polyamides, polyimides, polyethersulphones, polyetheretherketones, polyurethanes, polyethylene, polyphenylene sulphides, acrylonitrile butadiene styrene, polyarylate, polysulphone, polyethersulphone, and polyphenylene ether. In some embodiments it is even envisioned that the fiber be reinforced with thermosetting polymers, e.g., epoxies, unsaturated polyester resins, melamine, pheno/formaldehyde resins, polyurethanes and etcetera. However, thermoplastic polymers for use herein must withstand the temperatures and pressures necessary to thermoplastically form the laminate structures, for example, withstand temperatures in the 425° C. to 475° C. region and pressures in the 1,000 lb/s range.

In some embodiments, fiber density may be modified to fabricate fiber layers of different strength or flexibility based on the BMG-fiber laminate use. In some embodiments the fiber layer is continuous throughout the layer and in other embodiments the fiber layer is non-continuous throughout the fiber layer, having areas within the laminate structure where the fiber layer is limited or non-existent. It is also envisioned that where a BMG-fiber laminate has two or more fiber layers, the layers may be of the same or different fiber and fiber density dependent on the need. For example a BMG-fiber laminate having a first fiber layer of carbon and a second layer of titanium, or a first layer of carbon and a second fiber layer of aluminum. As above, the density of fiber in each layer is dependent on the ultimate laminate use.

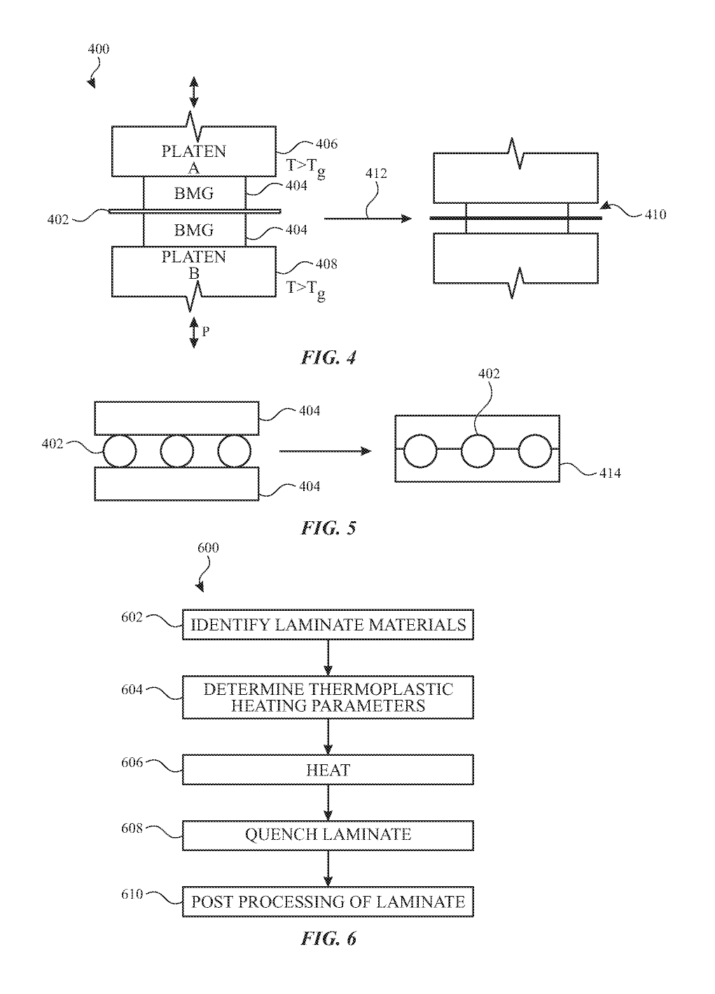

FIG. 3 shows one possible fiber weave structure for use in embodiments described herein. The fiber layer 300 in FIG. 3 is preformed having the required dimensions for an exemplary BMG-fiber laminate, for example, a dry carbon fiber weave piece having 1.5″×1.5″ dimensions for use in making a 1.6″×1.6″ BMG-fiber laminate. The weave structure in FIG. 3 is exacerbated to show the weave structure of the fiber. First horizontal weave members 302 can be weaved in an appropriate pattern with vertical weave members 304. In this pattern, the horizontal and vertical weave members meet at a substantially perpendicular angle 306.

Alternative embodiments allow for fiber to be added to a BMG layer based on the dimensions of the BMG layer. As can be envisioned, any useful combination of fibers or fiber weave structures can be used in accordance with embodiments herein, the design only being limited by the parameters of the desired composite structure of the BMG-fiber laminate.

### BMG-Fiber Laminate Feedstock

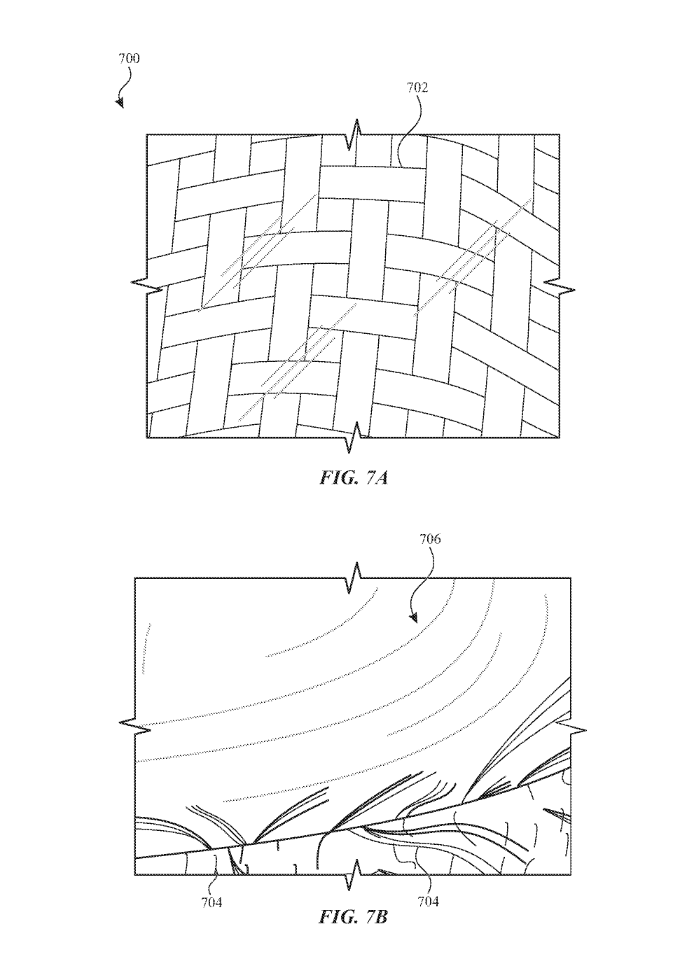

Fabrication of a BMG-laminate feedstock 400 in accordance with one embodiment herein is shown in FIG. 4. A composite of one fiber layer 402 sandwiched between two thin BMG layers 404 is prepared and placed in a hot forming press (left panel). Platen A 406 is heated to a temperature above the Tg of the platen A contacting BMG layer. Platen B 408 is heated to a temperature above the Tg of the platen B contacting BMG layer. BMG layers can be composed of the same or different compositions of alloy elements as required by the BMG-fiber laminate. Hot forming temperatures should not exceed either or the BMG layer's Tx. Finally, hot forming temperatures must remain below the temperature at which the fiber layer would be damaged. So where appropriate, platen heating temperatures should exceed the BMG Tg, not exceed the BMG Tx, and should take into account the fiber layers damage or degradation temperature. Where a fiber or fiber matrix is damaged by the required BMG thermoplastic heating temperature, an alternative fiber must be utilized (for example, a thermoplastic heating temperature that will burn out carbon fibers should not be utilized in a laminate having a carbon fiber layer) or, where the fiber is desired, an alternative BMG alloy must be used having a more appropriate Tg.

FIG. 4 also shows compression of the BMG-fiber composite with hot forming to form a viscous BMG-fiber laminate 410 (right panel). Sufficient pressure is applied, for example 1000 pounds per square inch, during the hot forming process, in this case by a press. The resultant BMG-fiber laminate is immediately quenched to provide a quenched BMG-fiber laminate in accordance to embodiments herein 412.

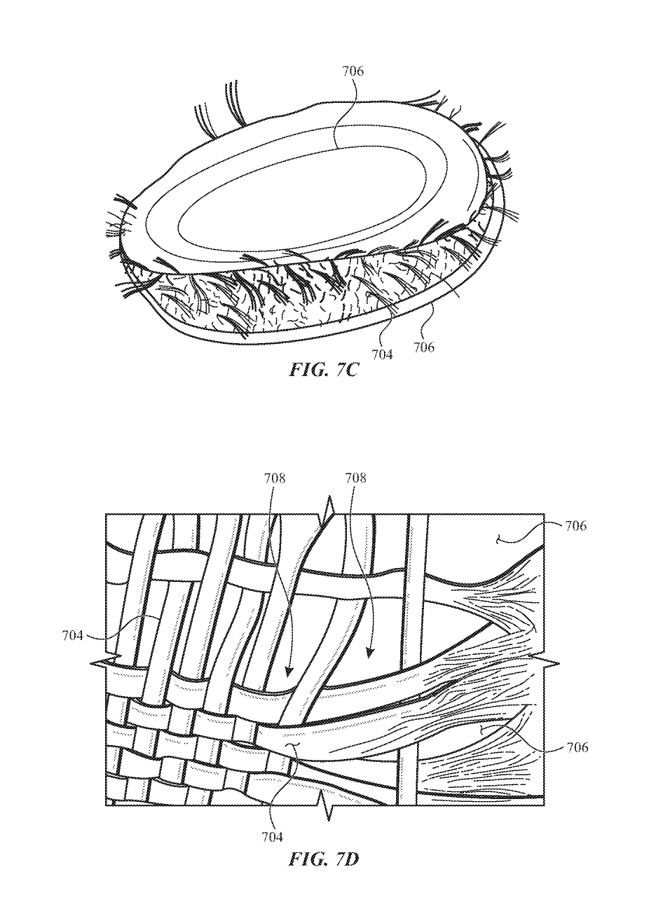

FIG. 5 provides a cross-sectional view of the same composite where a fiber layer 402 is sandwiched between two appropriately thick BMG layers 404 (left panel). With heat and pressure sufficient for thermoplastic forming of the BMG layers, the sandwiched fiber layer is surrounded and mechanically bonded to the now viscous BMG 414 (right panel). Embodiments herein include heating the composite layers under vacuum and/or under an inert atmosphere to remove impurities, particularly oxygen. In one aspect the inert atmosphere may be argon, although other inert atmospheric gases may be used.

Heating of BMG-fiber laminate composite structures can be performed using platens, induction heating, laser based heating or electron beam heating. In embodiments herein the heating must be sufficient to reach the BMG Tg.

In one embodiment, a BMG-fiber laminate is considered having one or more fiber layers and corresponding BMG layers where each fiber layer is sandwiched between two BMG layers. For example, a one fiber layer laminate would include 2 layers of BMG, a two fiber layer laminate would include 3 layers of BMG (BMG/Fiber/BMG/Fiber/BMG), a 3 layer fiber laminate would include 4 layers of BMG, and the like. In alternative embodiments, multiple layers of fiber may be sandwiched between two BMG layers, for example, BMG/Fiber layer 1/Fiber layer 2/BMG. In this embodiment, sufficient BMG must be provided to viscously integrate and mechanically bond both fiber layers, likely requiring thicker starting BMG layers. As can be envisioned, BMG-fiber laminates may include a combination of multiple fiber layers integrated with BMG layers combined with alternating BMG/fiber layers, for example BMG/Fiber layer 1/Fiber layer 2/BMG/Fiber layer 3/BMG, and the like.

The type, structure, size and number of fiber layers is identified for a particular use where any one layer may include multiple types of fibers of fiber weaves, or any one laminate may include a first fiber layer of a first type of fiber and a second fiber layer of a second type of fiber. Design options are diverse and dependent upon the laminate use. BMG composition and thickness are also identified for particular uses. In general, the BMG layers should be of adequate size for coverage to fully encapsulate the sandwiched fiber layer. However, there may be occasion to fabricate BMG-fiber laminates having the fiber layer extend out from between the BMG layers. It is also envisioned that laminate feedstock embodiments may have non-uniform or non-continuous layers of fiber sandwiched between corresponding BMG layers. As above, feedstock is designed for an intended use, for example, a BMG-laminate that only requires fiber layers for strength at the edges could be designed by layering the fiber only along the BMG edges.

Correctly sized and formed fiber layers are placed between appropriately thick and sized BMG sheets. Layers are merged together in a single thermoplastic forming step, or via multiple steps, to add one layer at a time. In a typical embodiment the thermoplastic forming is accomplished though hot forming with heated and pressed platens (heat greater than the BMG Tg) or directly using induction heating, laser heating or electron beam heating. In some embodiments the hot forming is performed under vacuum and under inert atmosphere. In one aspect the inert atmosphere is argon.

Once the BMG layers have been sufficiently heated, the softened alloy has a viscosity that allows for flow under applied pressure (and optional vacuum) to intermingle and bond with BMG from the opposite layer, forming a BMG-fiber laminate. One advantage of the embodiments herein is that BMG-fiber laminates herein are prepared using relatively low temperatures (for amorphous alloys), between the Tg and Tx for the BMG layers, e.g., 450° C. These lower temperature requirements for thermoplastic forming are sufficiently low to not damage or degrade most commonly used fiber materials. For example, a fiber layer of dry carbon begins to degrade at temperatures above 500° C. The dry carbon would be undamaged at 450° C., the required Tg for the BMG.

Thermoplastically formed laminates are quenched and, where required, post-processed into other geometries by traditional manufacturing methods such as machining, water jet cutting, etc. The quenching step is then performed to avoid crystallization of the BMG portion of the laminate, and can be as shown for trajectory (4) in FIG. 2, where the BMG is heated above the Tg and cooled without touching the crystallization nose region.

BMG-fiber laminate embodiments herein are typically of a thickness not attainable for BMG alone. Also, as shown by the schematic in FIG. 5, the fiber is mechanically bonded within the BMG, unlike other metal-fiber laminates which rely upon adhesives to maintain the laminate structure.

### Methods

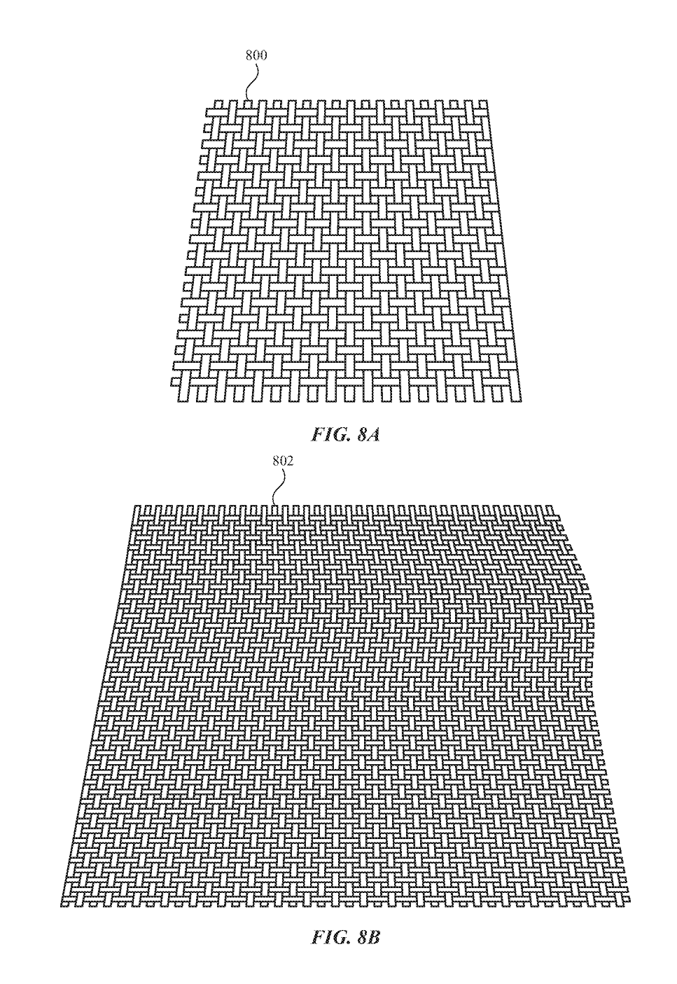

FIG. 6 shows a flow chart for fabricating a BMG-fiber laminate in accordance with embodiments herein. In one embodiment a fiber/BMG combination is identified for a particular laminate use 602. In one aspect the BMG hot forming temperature (between Tg and Tx) is ensured to be below the damage or degradation temperature of the desired fiber layer 604. Appropriately positioned BMG layers are positioned and thermoplastically heated to allow viscous BMG to flow between and through the fiber layer 606. In one aspect the thermoplastic heating step is accomplished by hot forming or by induction, laser or electron beam heating.

Once the BMG is fully integrated and intermingled between and through the fiber layer or layers, the BMG-fiber laminate is quenched to avoid crystal formation in the now intermingled BMG 608. Quenching can be accomplished using a heat sink or appropriate cooling, for example water or air cooling. Feedstock BMG-fiber laminates can undergo post-processing manufacturing steps to form new geometries where appropriate 610. In one aspect the manufacturing step is by machining and in another aspect the manufacturing step is through the use of water jet cutting.

### Forming Near-to-Net Shaped Laminate Parts

Embodiments herein also include the fabrication of near-to-net shaped laminate parts. In one embodiment a mold of appropriate shape, for example shaped to allow formation of smart phone housing, has a first layer of BMG heated and pressed into the mold shape. Aspects allow for thermoplastic heating and pressing to be performed under vacuum and under inert gas. A first layer of fiber or fiber weave is then positioned within the mold on the first formed BMG layer. The fiber, being flexible, may be embedded in the viscous BMG layer, or after the BMG layer is quenched in the mold. A second BMG layer is thermoplastically heated and forced into the mold over the fiber layer to form a near-to-net shaped molded laminate. Additional fiber and BMG layers may be added to a required BMG-fiber laminate thickness and strength.

In an alternative embodiment, the BMG and fiber layers are pre-positioned together to form the appropriate laminate composite structure, and then thermoplastically heated and pressed into the near-to-net shape part mold. Once heated to the appropriate temperature and pressed into the mold, the mold may act as a heat sink or include cooling, for example cooling lines, to quench the shaped part. As discussed previously, quenching is performed to minimize crystallization of the BMG alloy.

### Electronic Devices

Embodiments herein can be valuable in the fabrication of electronic devices and/or articles integrated in electronic devices. Embodiments herein provide the BMG-fiber laminate feedstock for these uses as well as near-to-net shaped parts integral to electronic devices.

An electronic device herein can refer to any electronic device known in the art, for example, mobile telephone, smart phone, computer, electronic e-mail sending or receiving device, wearable electronic devices, health monitory devices, DVD player, Blue-Ray disc player, video game console, and the like. Electronic device or articles integrated into an electronic device can also refer to a display, TV monitor, book-reader, web-browser, computer monitor, and the like or to accessories such as casings, laptop housings, smart phone housings, laptop track pads, keyboard, mouse, speakers, etc.

BMG feedstock provides the high strength and longevity of an amorphous alloy to a thickness useable in a housing, for example, of an electronic device. Housings composed of a BMG-laminate can form enclosures with a glass article. The cover sheet can be sapphire, polished glass or other like material. The enclosure formed by the BMG-laminate and cover sheet can form an interior volume that is configured to enclose various electronic components of electronic device. The BMG-laminate may define an opening in which a display is positioned. The display may include a liquid crystal display (LCD), an organic light-emitting diode (OLED) display, or other suitable display elements of components. In some embodiments, the BMG-laminate is fabricated in a near-to-net shape to the desired contour of the exterior surface of the electronic device.

### Examples

### Example 1: BMG-Carbon Weave Laminate

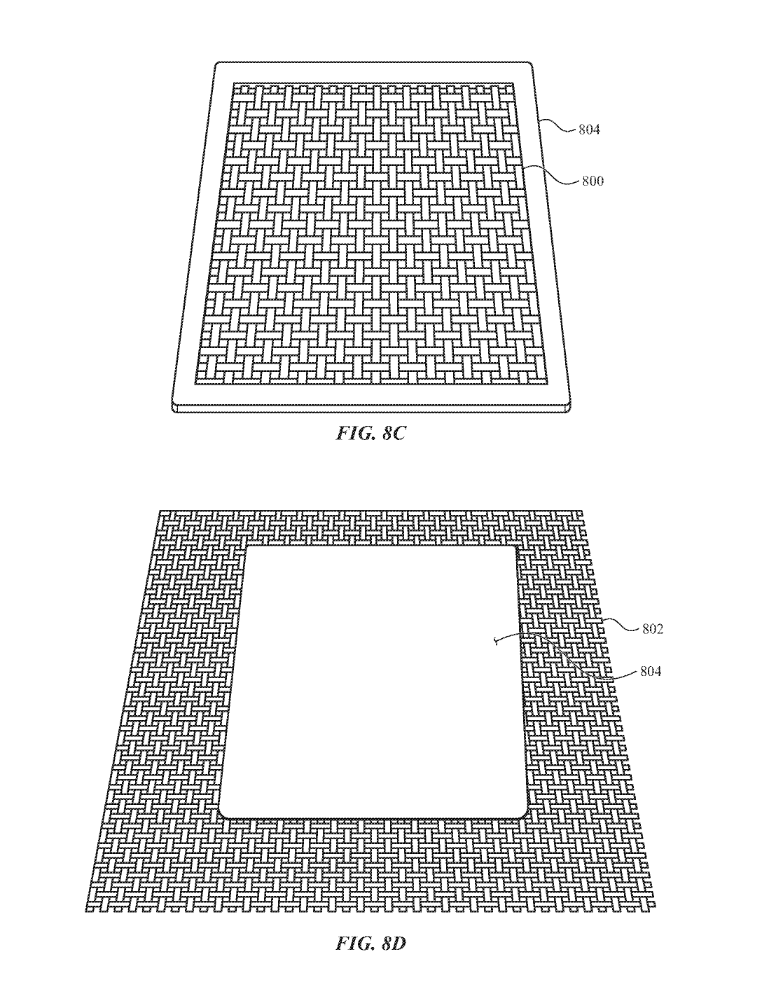

FIGS. 7A-D shows a BMG-carbon weave fabricated in accordance with an embodiment herein. FIG. 7A shows a top view of a fabricated BMG-carbon weave 700. Note the carbon fiber weave is embedded between two thin layers of BMG. The carbon fiber plain weave pattern 702 can be seen by the naked eye. In order to illustrate the laminate nature of the BMG-carbon weave, the fiber carbon weave layer 704 was made larger than the top and bottom BMG layers 706. As shown in FIG. 7B, the larger area carbon fiber weave 704 sticks out from between the two thermoplastically deformed BMG layers 706. FIG. 7C provides a perspective top view of the BMG-carbon weave laminate consisting of one carbon fiber weave layer sandwiched between two BMG plates. The two BMG plates bond to each through the carbon fiber weave layer to provide the significantly improved laminate strength parameters. Finally FIG. 7D shows a single BMG layer 706 thermoplastically formed into a carbon fiber layer 604 to illustrate the flow of the BMG in between the fibers (arrow 708) during laminate forming.

Example 1 illustrates the significant improvement of BMG-fiber laminates over other metal-laminates in the manner by which the fiber weave is mechanically embedded in the BMG. Conventional metal-laminates require adhesives and chemical bonding to form the laminate, an inferior bonding to embodiments described herein.

### Example 2: BMG-Carbon Weave Fabrication

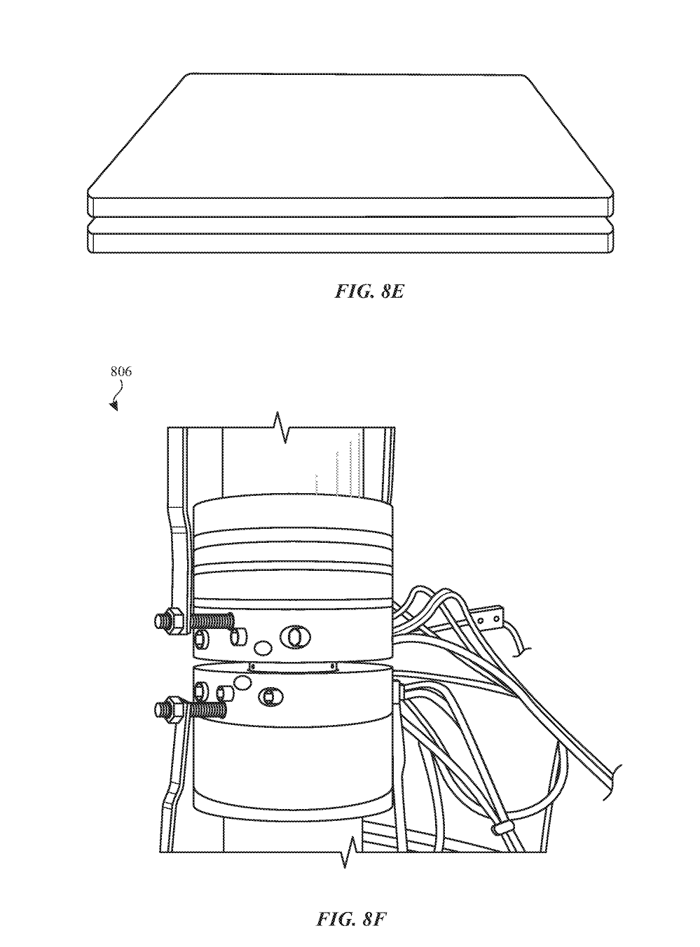

FIGS. 8A-F show the fabrication of a BMG-carbon fiber weave in accordance with embodiments herein. Various size fibers or fiber weaves can be used to prepare BMG-fiber laminates, the size typically determined by the required size of the feedstock. FIG. 8A shows a 1.5″×1.5″ piece of dry carbon fiber 800 suitable as the fiber layer in a BMG-fiber laminate as does FIG. 8B, which shows a 3″×3″ piece of dry carbon fiber 802. FIG. 8C shows the positioning of the 1.5″×1.5″ fiber 800 on a thin sheet of 1.77″×1.77″ BMG 804. In this embodiment the thin BMG sheet provides an overlap which during formation with a second 1.77″ sheet would fully encapsulate the 1.5″ fiber layer (see FIG. 8E). FIG. 8D shows the alternative where a 3″×3″ piece of fiber 802 is positioned between two 1.77″ thin BMG sheets. Finally, FIG. 8F shows a hot forming set-up 806 for fabrication of one embodiment of the BMG-laminate embodiments as described herein.

Example 2 shows the utility of making feedstock BMG-fiber laminates using carbon fiber weaves and pre-formed thin BMG sheets.

### Example 3: Hot Formed and Quenched BMG-Carbon Fiber Laminates

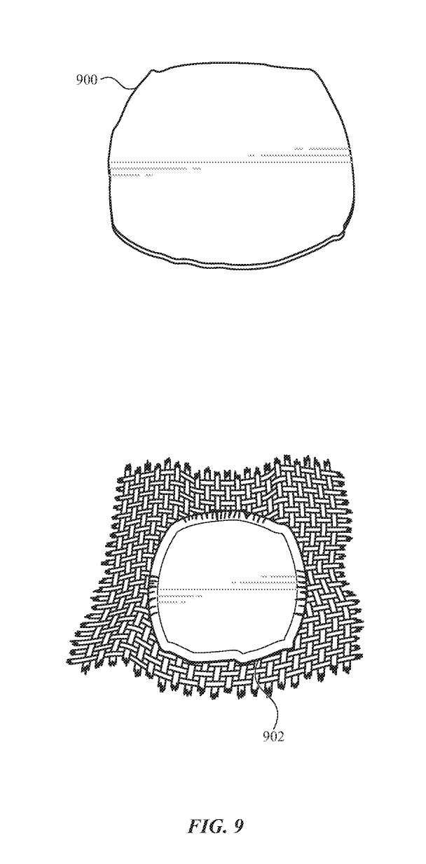

FIG. 9 provides views of the two laminates fabricated in Example 2. The top panel shows the hot formed, fully encapsulated, 1.77″×1.77″ BMG/1.5″×1.5″ fiber weave laminate 900. The bottom panel shows the hot formed, 1.77″×1.77″ BMG/3.0″×3.0″ fiber weave laminate 902. The hot formed and quenched laminates, as shown in FIG. 9, show the BMG thermoplastically formed in and around and through the carbon weave layer, again showing the utility of mechanical bonding over chemically bonding. The BMG-carbon fiber laminates were quenched at an appropriate temperature.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device comprising:
a housing composed of a BMG-fiber laminate;
a display positioned within the housing; and
a cover positioned over the display; wherein
the BMG-fiber laminate includes one fiber layer embedded between two bulk metallic glass layers.

2. The electronic device of claim 1, wherein the fiber layer is a carbon fiber layer, aluminum fiber layer, or combination of a carbon and aluminum fiber layers.

3. The electronic device of claim 1, wherein the housing of BMG-fiber layers has a thickness from 0.5 mm to 3 mm.

4. The electronic device of claim 1, wherein the electronic device is a smart phone or wearable electronic device.

5. A laminate comprising:
a fiber layer embedded between a first and a second bulk metallic glass layer, the first and second bulk metallic glass layers mechanically bonding to each other through the embedded fiber layer.

6. The laminate of claim 5, wherein the fiber layer is a fiber weave.

7. The laminate of claim 5, wherein the fiber layer is a fiber composed of carbon, polyimide film, titanium, aluminum, glass, aromatic polyamide film or combinations thereof.

8. The laminate of claim 5, wherein the fiber layer is a first fiber layer; and further comprising:
a second fiber layer and a third metallic glass layer, wherein the second fiber layer is embedded between the second bulk metallic glass layer and the third bulk metallic glass layer and the second and third bulk metallic glass layers are bonded to each other through the embedded second fiber layer.

9. The laminate of claim 5, wherein the fiber layer is a continuous layer of fiber embedded between the first and second bulk metallic glass layers.

10. The laminate of claim 5, wherein the fiber layer is a non-continuous layer of fiber embedded between the first and second bulk metallic glass layers.

11. A method comprising:
molding a BMG-fiber laminate to form a desired part; and
quenching the desired part at a cooling rate above the critical cooling rate for the BMG-fiber laminate.

12. The method of claim 11, wherein the desired part is a housing for an electronic device.

13. The method of claim 12, wherein the electronic device is a mobile phone.

14. The method of claim 11, wherein the molding further comprises a mold that acts as a heat-sink for quenching the desired part.

15. The method of claim 11, wherein the molding further comprises:
heating and pressing two BMG layers onto a fiber layer at a temperature above the glass transition temperature (Tg) of the two BMG layers wherein the BMG layers form mechanical bonds with the fiber layer such that the two BMG layers and fiber layer form the BMG-fiber laminate.

16. The method of claim 15, wherein the heating is to a temperature between the Tg and a Tx of the BMG layers.

17. The method of claim 15, further comprising:
post processing the BMG-fiber laminate into a geometry useful for an electronic device housing.

18. The method of claim 15, wherein the electronic device is a mobile phone.

19. The method of claim 15, wherein the heating is performed under vacuum.

20. The method of claim 15, wherein the heating is done in an inert atmosphere.
